(19) United States
(12) Patent Application Publication
(10) Pub. No.: US 2003/0008091 A1
(43) Pub. Date: Jan. 9, 2003

(54) Pipe, especially pressure pipe

(76) Inventors: Roland Konrad, Linz (AT); Karl Ebner, Rohr/Kremstal (AT); Klaus Bernreiter, Linz (AT); Johannes Wolfschwenger, Niederneukirchen (AT)

Correspondence Address: Collard & Roe, 1077 Northern Boulevard, Roslyn, NY, 11576, US

(21) Appl. No.: 09/601,067

(22) PCT Filed: Feb. 4, 1998
(86) PCT No.: PCT/AT98/00023

(51) Int. Cl. B32B 1/08

(52) U.S. Cl. 428/36.9

(57) ABSTRACT

The description refers to a pipe, especially a pressure pipe, with a pipe body extruded from polypropylene. To achieve a high resistance to a rapid crack formation, it is suggested that the pipe body consists of a polypropylene in a predominantly hexagonally crystallised β-form with a nucleation agent based on an amide.

The invention relates to a pipe, especially pressure pipe, with a pipe body extruded of polypropylene.

Due to the favorable properties of polypropylene, mainly in terms of a good media resistance and a good stability under pressure, pipe bodies extruded of polypropylene are frequently applied in pipelines of chemical plants and facilities. In spite of these good material properties, cracks may develop under unfavorable conditions at high impact loads of the pipe body, which crack expands explosively and at acoustic velocity, especially when pipe bodies are under a certain internal pressure, as is the case with gas pipelines. The resistance to such a rapid propagation of the cracks is established via a standardized process (e.g. DIS 13477), in which a pipe body admitted with a certain internal pressure is fired at with a projectile under specified conditions in such a way that an expanding crack is created. The crack length is taken as a standard for the resistance to a rapid crack expansion, with a rapidly expanding crack being defined as a crack, the length of which exceeds 4.7 times the outer diameter of the pipe body.

Therefore, the objective of the invention is to provide a pipe, especially a pressure pipe, of the above mentioned kind in such a way that a high resistance to a rapid expansion of a crack is ensured.

This objective of the invention is achieved by a pipe body consisting of a polypropylene in a predominantly hexagonally crystallised p-form with a nucleation agent based on an amide.

Surprisingly, it has turned out that a piece of pipe consisting of a polypropylene in a hexagonal β-crystalline form instead of the common monoclinic α-crystalline form shows a high resistance to rapid crack propagation, if crystallisation of the polypropylene is produced out of a melting in the presence of a β-nucleation agent based on an amide. Although various nucleation agents based on amide can be applied, β-nucleation agent of N,N′ dicyclohexyl-2.6-naphtalenedicarboxamide has turned out the most favorable in this context.

For nucleation of the β-crystalline form of the polypropylene various nucleation agents are known, with those on the basis of amides (EP 0 557 721 A2) being meant to combine the advantage of an especially effective nucleation with that of being neutral in color. Due to the low melting point and the low deformation resistance when subjected to heat, these polypropylene materials crystallised in β-form are mainly applied for packagings, plates and foils, especially, if these commodities are intended for printing. Therefore, such a state-of-the-art cannot furnish any new ideas to achieve the objective of the invention.

On the basis of the following examples of embodiment the suprising effect of the invention, compared with a conventional pipe body of polypropylene in a predominantly α-crystalline form, shall be made clear:

### EXAMPLE 1

A homopolymer polypropylene was admixed with 0.1 weight percent of N,N′ dicyclohexyl-2.6-naphtalenedicarboxamide as a β-nucleation agent with the usual additives (0.1 weight percent glycerol monostearate, 0.3 weight percent pentaerythrityl-tetrakis [3-(3.5-di-tert-butyl-4-hydroxyphenyl)-propionate], 0.1 weight percent tris-(2.4-di-tert-butylphenyl)-phosphite, 0.1 weight percent calcium stearate and 0.5 weight percent P,D′-thiodipropionic acid distearylester). From this material a pipe body was extruded under usual conditions, with a wall thickness of 10 mm and an outer diameter of 110 mm.

### EXAMPLE 2

A homopolymer polypropylene was admixed with 0.1 weight percent N,N′-1.4 cyclohexanebis(benzamide) as a β-nucleation agent with the additives applied in example 1, and under the conditions of example 1 a pipe body of the same dimensions was extruded.

### EXAMPLE 3

A polypropylene according to the examples 1 and 2 was admixed with a β-nucleation agent not based on an amide, of 0.1 weight percent azelaic acid and 0.1 weight percent calcium carbonate with the same additives, and, again, a pipe body of the same dimensions was produced.

### EXAMPLE 4

A polypropylene in accordance with the other examples was admixed with 0.1 weight percent talcum as an α-nucleation agent beside the already specified additives, to get a pipe body of the same diemensions of a polypropylene having a common α-cystalline form.

According to the test conditions as specified in standard DIS 13 477, the pipe bodies of a length of 775 mm were fired at with a projectile velocity of 20 m/s at a temperature of 0±2° C., with air as the testing medium and an internal pressure of the pipes of 4.5 bar. The test results can be inferred from the below table:

| Pipe body | Example 1 | Example 2 | Example 3 | Example 4 |
|---|---|---|---|---|
| Crack length [mm] | 240 | 270 | 532 | 645 |

From these test results it becomes immediately clear that the pipe bodies according to the examples 1 and 2 made of a polypropylene in β-crystalline form with an amide as a nucleation agent have a considerably higher resistance to a rapid crack propagation than the pipe bodies according to the examples 3 and 4. Moreover, a comparison of the test results of the examples 3 and 4 indicates that a polypropylene extruded with another p-nucleation agent with a predominantly β-crystalline form has resistance values similar to a polypropylene with α-nucleation. According to standard DIS 13 477, it can be put down that only the pipe bodies according to examples 1 and 2 do not have a crack formation with rapidly expanding cracks.

1. Pipe, especially pressure pipe, with a pipe body extruded of polypropylene, characterised in that the pipe body consists of a polypropylene in a predominantly hexagonally crystallised β-form with a nucleation agent based on an amide.

2. Pipe according to claim 1, characterised in that the β-nucleation agent consists of N,N′ dicyclohexyl-2.6-naphtalenedicarboxamide.
